(19) United States
(12) Patent Application Publication
(10) Pub. No.: US 2013/0173881 A1
(43) Pub. Date: Jul. 4, 2013

(54) CIRCUIT FOR SETTING A PLURALITY OF BLOCKS AS AN IN-SYSTEM PROGRAMMING AREA AND A DATA BUFFER AREA AND METHOD THEREFORE

(71) Applicants: You-Chang Hsiao, Hsinchu City (TW); Ding-Yun Chen, Hsinchu City (TW)

(72) Inventors: You-Chang Hsiao, Hsinchu City (TW); Ding-Yun Chen, Hsinchu City (TW)

(21) Appl. No.: 13/339,376

(22) Filed: Dec. 29, 2011

(51) Int. Cl. G06F 12/00

(52) U.S. Cl. 711/170; 711/E12.001

(57) ABSTRACT

A method for setting a plurality of blocks as an in-system programming area and a data buffer area includes generating a plurality of select signals; setting some blocks of the plurality of blocks as blocks of the in-system programming area and other blocks of the plurality of blocks as blocks of the data buffer area according to the plurality of select signals.

### BACKGROUND OF THE INVENTION

1. Field of the Invention

The present invention is related to a circuit and method therefore that can set a plurality of blocks, and particularly to a circuit and method therefore that can set a plurality of blocks as an in-system programming area and a data buffer area.

2. Description of the Prior Art

Please refer to FIG. 1. FIG. 1 is a diagram illustrating a memory array 100. The memory array 100 is divided into a read only memory area 102, a random access memory area 104, and an input/output program area 106, where the random access memory area 104 is further divided into an in-system programming area 1042 and a data buffer area 1044. The read only memory area 102 is used for storing fixed programs, the input/output program area 106 is used for storing programs for controlling input/output devices, the in-system programming area 1042 is used for storing memory drivers, and the data buffer area 1044 is used for storing data.

Each of the read only memory area 102, the input/output program area 106, the in-system programming area 1042, and the data buffer area 1044 has a block set. Please refer to FIG. 2. FIG. 2 is a diagram illustrating a block set of the read only memory area 102 and an address line 108. As shown in FIG. 2, the block set of the read only memory area 102 has 4 blocks 1021-1024, where each block of the 4 blocks 1021-1024 includes 256 memory cells, and number of blocks of the read only memory area 102 can vary with a requirement of a user. As shown in FIG. 2, the address line 108 is divided into a block address area 1082 and a memory cell address area 1084. Then, the user can determine one corresponding block of the 4 blocks 1021-1024 of the read only memory area 102 through block address signals of the block address area 1082 of the address line 108 because, and determine one corresponding memory cell of the corresponding block of the 4 blocks 1021-1024 through the memory cell address area 1084 of the address line 108.

However, because size of the in-system programming area 1042 is fixed, the user needs to know whether size of a program intended to be written in the in-system programming area 1042 is over the size of the in-system programming area 1042 when the user develops the program intended to be written in the in-system programming area 1042. Thus, the in-system programming area 1042 with fixed size may reduce flexibility of the program programmed by the user.

### SUMMARY OF THE INVENTION

An embodiment provides a circuit for setting a plurality of blocks as an in-system programming area and a data buffer area. The circuit includes an in-system programming address decoding unit, a data buffer address decoding unit, and a block select unit. The in-system programming address decoding unit is used for generating a plurality of first decoding signals corresponding to the plurality of blocks according to a plurality of block address signals, and a select signal. The data buffer address decoding unit is used for generating a plurality of second decoding signals corresponding to the plurality of blocks according to the plurality of block address signals and the select signal. The block select unit including a plurality of select units, where each select unit corresponds to one block of the plurality of blocks, one first decoding signal of the plurality of first decoding signals, one select signal of a plurality of select signals, and one second decoding signal of the plurality of second decoding signals, and determines to output the first decoding signal or the second decoding signal to enable the block according to the select signal.

Another embodiment provides a method for setting a plurality of blocks as an in-system programming area and a data buffer area. The method includes generating a plurality of select signals; setting some blocks of the plurality of blocks as blocks of the in-system programming area or the data buffer area according to the plurality of select signals.

The present invention provides a circuit for setting a plurality of blocks as an in-system programming area and a data buffer area and method thereof utilize a determination unit to compare size of a program intended to be written in the in-system programming area with size of the in-system programming area, and generate a plurality of select signals according to a determination result, or a plurality of select signals set by a user. Then, a block select unit can set some blocks of the plurality of blocks as blocks of the in-system programming area and set other blocks of the plurality of blocks as blocks of the data buffer area according to the plurality of select signals. Thus, the present invention can not only increase flexibility of programming-program of a designer of a memory array, but also reduce a revision probability for the memory array due to a structure problem of the memory array.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a memory array.

FIG. 2 is a diagram illustrating a block set of the read only memory area and an address line.

FIG. 3 is a diagram illustrating a circuit for setting 8 blocks of a random access memory area of a memory array as an in-system programming area and a data buffer area according to an embodiment.

FIG. 4 is a diagram illustrating the in-system programming address decoding unit.

FIG. 5 is a diagram illustrating the data buffer address decoding unit.

FIG. 6 is a diagram illustrating the block select unit.

FIG. 7 is a diagram illustrating the select unit.

FIG. 8 and FIG. 9 are diagrams illustrating the block select unit setting some blocks of the 8 blocks as blocks of the in-system programming area and other blocks of the 8 blocks as blocks of the data buffer area according to the 8 select signals when the determination unit generates 8 select signals according to size of a program intended to be written in the in-system programming area.

FIG. 10 is a flowchart illustrating a method for setting a plurality of blocks as an in-system programming area and a data buffer area according to another embodiment.

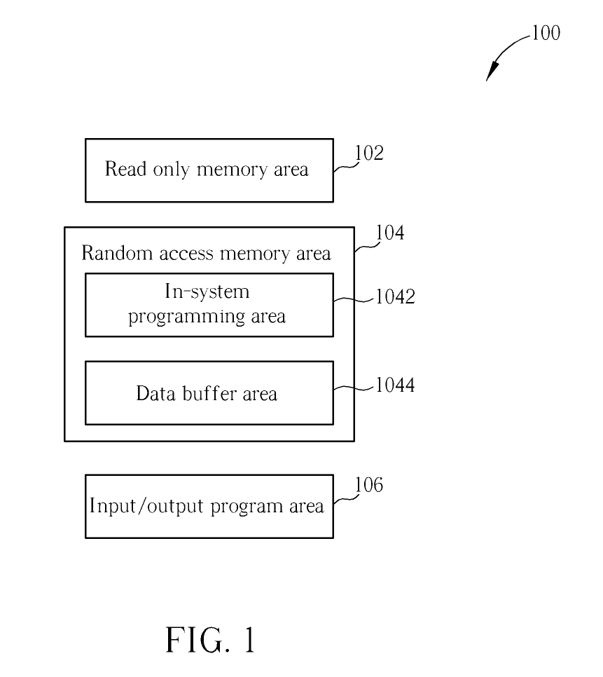

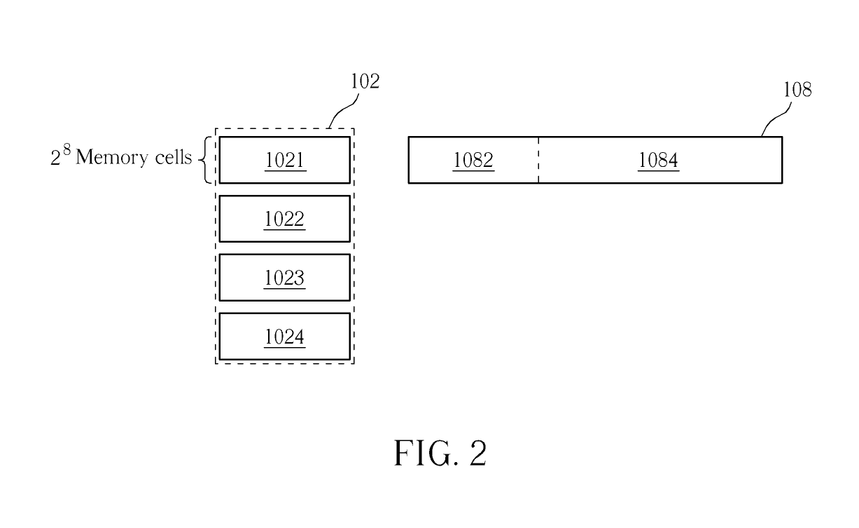

### DETAILED DESCRIPTION

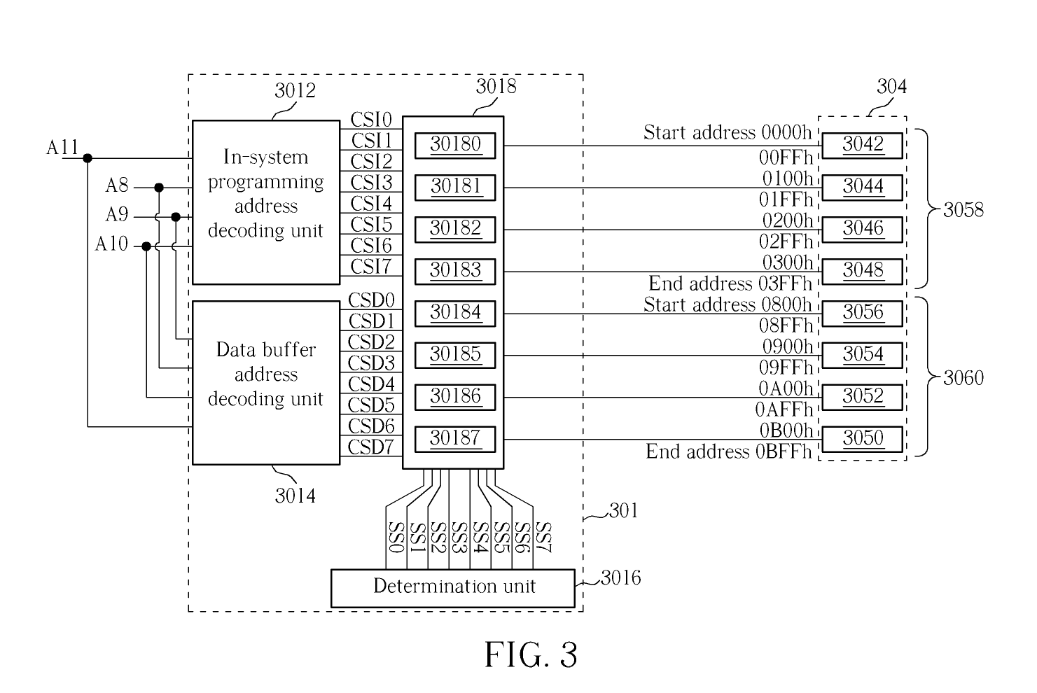

Please refer to FIG. 3. FIG. 3 is a diagram illustrating a circuit 301 for setting 8 blocks 3042-3056 of a random access memory area 304 of a memory array as an in-system programming area 3058 and a data buffer area 3060 according to an embodiment, where each block of the 8 blocks 3042-3056 includes 256 memory cells and is a random access memory block. The blocks 3042-3048 of the 8 blocks 3042-3056 are pre-set as blocks of the in-system programming area 3058 (a start address is 0000h and an end address is 03FFh) and the blocks 3050-3056 of the 8 blocks 3042-3056 are pre-set as blocks of the data buffer area 3060 (a start address is 0800h and an end address is 0BFFh). The circuit 301 includes an in-system programming address decoding unit 3012, a data buffer address decoding unit 3014, a determination unit 3016, and a block select unit 3018. The in-system programming address decoding unit 3012 is used for generating 8 first decoding signals CSI0-CSI7 corresponding to the 8 blocks 3042-3056 according to 3 block address signals (a first block address signal A8, a second block address signal A9, and a third block address signal A10) and a select signal A11, where the first block address signal A8, the second block address signal A9, the third block address signal A10, and the select signal A11 are binary signals. The data buffer address decoding unit 3014 is used for generating 8 second decoding signals CSD0-CSD7 corresponding to the 8 blocks 3042-3056 according to the 3 block address signals and the select signal A11. The determination unit 3016 is used for comparing size of a program intended to be written in the in-system programming area 3058 with size of the in-system programming area 3058 (that is, size of the blocks 3042-3048), and generating 8 select signals SS0-SS7 according to a determination result. But, the present invention is not limited to the determination unit 3016 generating the 8 select signals SS0-SS7. In another embodiment of the present invention, the 8 select signals SS0-SS7 can be set by a user. The block select unit 3018 includes 8 select units 30180-30187. Each select unit of the 8 select units 30180-30187 corresponds to one block of the 8 blocks 3042-3056, one first decoding signal of the 8 first decoding signals CSI0-CSI7, one select signal of the 8 select signals SS0-SS7, and one second decoding signal of the 8 second decoding signals CSD0-CSD7, and determines to output the first decoding signal or the second decoding signal to enable the block according to the select signal. Therefore, the circuit 301 can set some blocks of the 8 blocks 3042-3056 as blocks of the in-system programming area 3058 and other blocks of the 8 blocks 3042-3056 as blocks of the data buffer area 3060 according to the size of the program intended to be written in the in-system programming area 3058. In another embodiment of the present invention, the circuit 301 can set some blocks of the 8 blocks 3042-3056 as blocks of the in-system programming area 3058 and other blocks of the 8 blocks 3042-3056 as blocks of the data buffer area 3060 according to a requirement of the user (that is, the use sets the 8 select signals SS0-SS7 according to the requirement). In addition, the present invention is not limited to the random access memory area 304 having the 8 blocks 3042-3056. That is, number of blocks of the random access memory area 304 can vary with a requirement of a designer of the memory array 300.

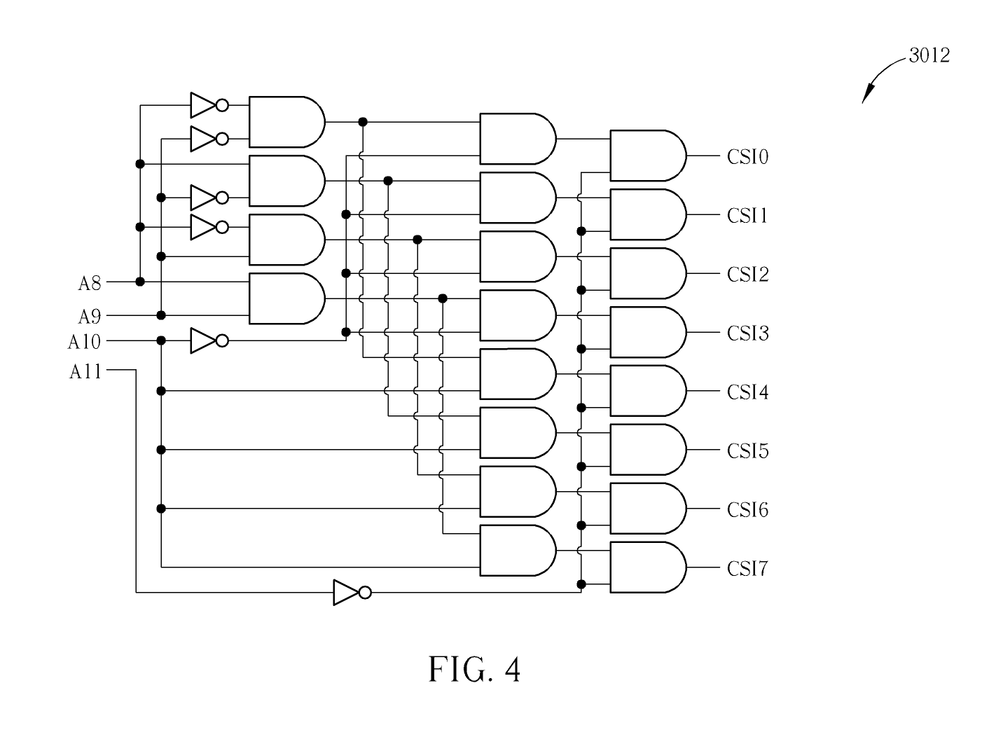

Please refer to FIG. 4. FIG. 4 is a diagram illustrating the in-system programming address decoding unit 3012. As shown in FIG. 4, the in-system programming address decoding unit 3012 generates the 8 first decoding signals CSI0-CSI7 corresponding to the 8 blocks 3042-3056 according to the 3 block address signals (the first block address signal A8, the second block address signal A9, and the third block address signal A10) and a select signal A11 through a plurality of AND gates, a plurality of inverters. The operating method of the in-system programming address decoding unit 3012 is well-known according to the connection shown in the FIG. 4, so coupling relationships between the plurality of AND gates and the plurality of inverters of the in-system programming address decoding unit 3012 are omitted for simplicity.

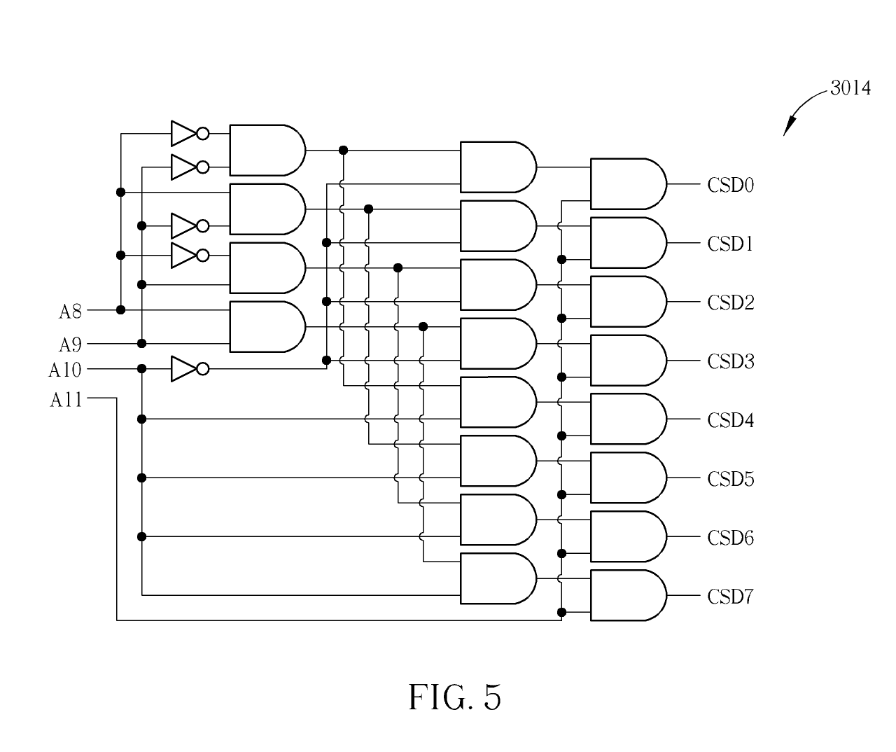

Please refer to FIG. 5. FIG. 5 is a diagram illustrating the data buffer address decoding unit 3014. As shown in FIG. 5, the data buffer address decoding unit 3014 generates the 8 second decoding signals CSD0-CSD7 corresponding to the 8 blocks 3042-3056 according to the 3 block address signals and the select signal A11 through a plurality of AND gates, a plurality of inverters. The operation method of the data buffer address decoding unit 3014 is well-known according to the connection shown in the FIG. 4, so coupling relationships between the plurality of AND gates and the plurality of inverters of the data buffer address decoding unit 3014 are omitted for simplicity.

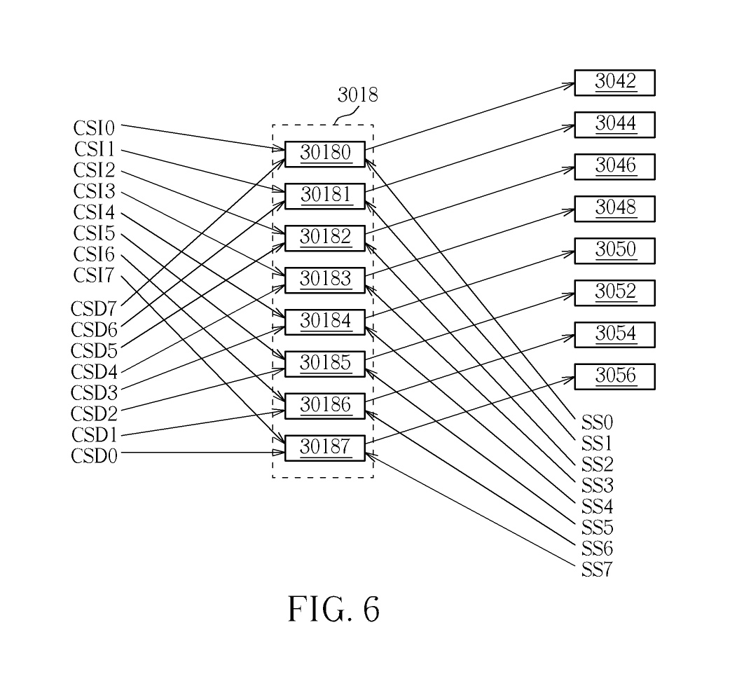

Please refer to FIG. 6. FIG. 6 is a diagram illustrating the block select unit 3018. The block select unit 3018 includes the 8 select units 30180-30187. As shown in FIG. 6, a first select unit 30180 of the 8 select units 30180-30187 corresponds to the 0^{th} first decoding signal CSI0, the 7^{th} second decoding signal CSD7, a first select signal SS0 of the 8 select signals SS0-SS7, and a 0^{th} block 3042 of the 8 blocks 3042-3056; a second select unit 30181 of the 8 select units 30180-30187 corresponds to the first first decoding signal CSI1, the 6^{th} second decoding signal CSD6, a second select signal SS1 of the 8 select signals SS0-SS7, and a first block 3044 of the 8 blocks 3042-3056; a third select unit 30182 of the 8 select units 30180-30187 corresponds to the second first decoding signal CSI2, the 5^{th} second decoding signal CSD5, a third select signal SS2 of the 8 select signals SS0-SS7, and a second block 3046 of the 8 blocks 3042-3056; a 4^{th} select unit 30183 of the 8 select units 30180-30187 corresponds to the third first decoding signal CSI3, the 4^{th} second decoding signal CSD4, a 4^{th} select signal SS3 of the 8 select signals SS0-SS7, and a third block 3048 of the 8 blocks 3042-3056; a 5^{th} select unit 30184 of the 8 select units 30180-30187 corresponds to the 4^{th} first decoding signal CSI4, the third second decoding signal CSD3, a 5^{th} select signal SS4 of the 8 select signals SS0-SS7, and a 4^{th} block 3050 of the 8 blocks 3042-3056; a 6^{th} select unit 30185 of the 8 select units 30180-30187 corresponds to the 5^{th} first decoding signal CSI5, the second second decoding signal CSD2, a 6^{th} select signal SS5 of the 8 select signals SS0-SS7, and a 5^{th} block 3052 of the 8 blocks 3042-3056; a 7^{th} select unit 30186 of the 8 select units 30180-30187 corresponds to the 6^{th} first decoding signal CSI6, the first second decoding signal CSD1, a 7^{th} select signal SS6 of the 8 select signals SS0-SS7, and a 6^{th} block 3054 of the 8 blocks 3042-3056; an 8^{th} select unit 30187 of the 8 select units 30180-30187 corresponds to the 7^{th} first decoding signal CSI7, the 0^{th} second decoding signal CSD0, an 8^{th} select signal SS7 of the 8 select signals SS0-SS7, and a 7^{th} block 3056 of the 8 blocks 3042-3056. But, the present invention is not limited to the 8 select units 30180-30187 corresponding to the second decoding signals CSD7-CSD0 in turn. That is to say, in another embodiment of the present invention, the 8 select units 30180-30187 corresponds to the second decoding signals CSD0-CSD7 in turn.

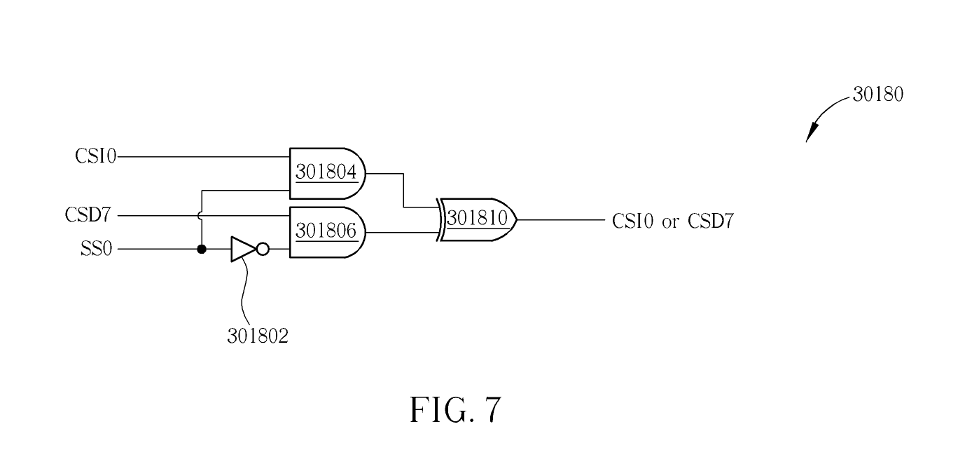

Please refer to FIG. 7. FIG. 7 is a diagram illustrating the select unit 30180. As shown in FIG. 7, the select unit 30180 outputs the 7^{th} second decoding signal CSD7 or the 0^{th} first decoding signal CSI0 according to the first select signal SS0 through an inverter 301802, a first AND gate 301804, a second AND gate 301806, and a OR gate 301810. Further, operational principles and a circuit structure of each select unit of other select units of the 8 select units 30180-30187 are the same as those of the select unit 30180, so further description thereof is omitted for simplicity.

As shown in FIG. 7, when the first select signal SS0 is a binary signal “0”, an output signal of the first AND gate 301804 is always a binary signal “0” (that is, the 0^{th} first decoding signal CSI0 is neglected), so the select unit 30180 outputs the 7^{th} second decoding signal CSD7 to enable the 0^{th} block 3042 according to the first select signal SS0. That is to say, the 0^{th} block 3042 is set as a block of the data buffer area 3060. When the first select signal SS0 is a binary signal “1”, an output signal of the second AND gate 301806 is always a binary signal “0” (that is, the 7^{th} second decoding signal CSD7 is neglected), so the select unit 30180 outputs the 0^{th} first decoding signal CSI0 to enable the 0^{th} block 3042 according to the first select signal SS0. That is to say, the 0^{th} block 3042 is set as a block of the in-system programming area 3058. Further, operational principles of each select unit of other select units of the 8 select units 30180-30187 are the same as those of the select unit 30180, so further description thereof is omitted for simplicity.

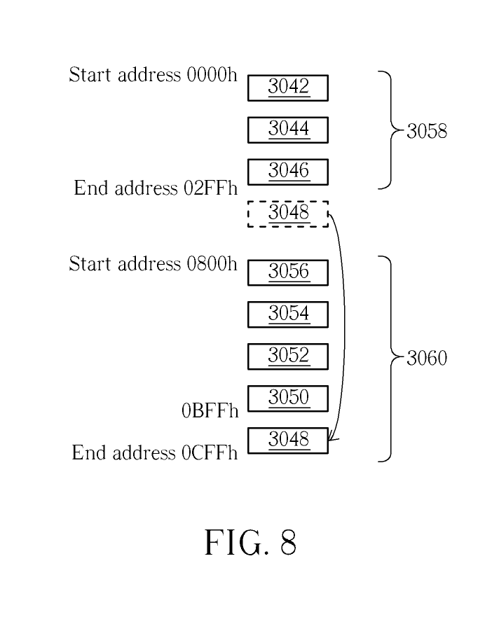

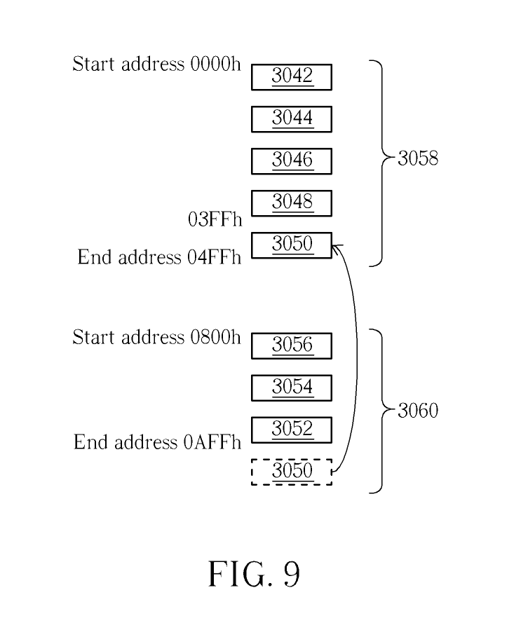

Please refer to FIG. 8 and FIG. 9. FIG. 8 and FIG. 9 are diagrams illustrating the block select unit 3018 setting some blocks of the 8 blocks 3042-3056 as blocks of the in-system programming area 3058 and other blocks of the 8 blocks 3042-3056 as blocks of the data buffer area 3060 according to 8 select signals SS0-SS7 when the determination unit 3016 generates the 8 select signals SS0-SS7 according to size of a program intended to be written in the in-system programming area 3058. As shown in FIG. 6, FIG. 7, and FIG. 8, 8 select signals SS0-SS7 generated by the determination unit 3016 according to size of a program intended to be written in the in-system programming area 3058 are binary signals “1”, “1”, “1”, “0”, “0”, “0”, “0”, “0” in turn. Because the first select signal SS0 is a binary signal “1”, the select unit 30180 outputs a 0^{th} first decoding signal CSI0 to enable the 0^{th} block 3042 according to the first select signal SS0. That is, the 0^{th} block 3042 is set as a block of the in-system programming area 3058; because the select signal SS1 is a binary signal “1”, the select unit 30181 outputs a first first decoding signal CSI1 to enable the first block 3044 according to the select signal SS1. That is, the first block 3044 is set as a block of the in-system programming area 3058; because the select signal SS2 is a binary signal “1”, the select unit 30182 outputs a second first decoding signal CSI2 to enable the second block 3046 according to the select signal SS2. That is, the second block 3046 is set as a block of the in-system programming area 3058; because the select signal SS3 is a binary signal “0”, the select unit 30183 outputs a 4^{th} second decoding signal CSD4 to enable the third block 3048 according to the select signal SS3. That is, the third block 3048 is set as a block of the data buffer area 3060; because the select signal SS4 is a binary signal “0”, the select unit 30184 outputs the third second decoding signal CSD3 to enable the 4^{th} block 3050 according to the select signal SS4. That is, the 4^{th} block 3050 is set as a block of the data buffer area 3060; because the select signal SS5 is a binary signal “0”, the select unit 30185 outputs the second second decoding signal CSD2 to enable the 5^{th} block 3052 according to the select signal SS5. That is, the 5^{th} block 3052 is set as a block of the data buffer area 3060; because the select signal SS6 is a binary signal “0”, the select unit 30186 outputs the first second decoding signal CSD1 to enable the 6^{th} block 3054 according to the select signal SS6. That is, the 6^{th} block 3054 is set as a block of the data buffer area 3060; because the select signal SS7 is a binary signal “0”, the select unit 30187 outputs a 0^{th} second decoding signal CSD0 to enable the 7^{th} block 3056 according to the select signal SS7. That is, the 7^{th} block 3056 is set as a block of the data buffer area 3060. As shown in FIG. 8, because the 0^{th} block 3042 corresponding to the 0^{th} first decoding signal CSI0, the first block 3044 corresponding to the first first decoding signal CSI1, and the second block 3046 corresponding to the second first decoding signal CSI2 are set as blocks of the in-system programming area 3058, the start address 0000h of the in-system programming area 3058 is not changed. However, the third block 3048 is set as the block of the data buffer area 3060, so the end address of the in-system programming area 3058 is changed from 03FFh (as shown in FIG. 3) to 02FFh. As shown in FIG. 8, because the third block 3048 corresponding to the 4^{th} second decoding signal CSD4, the 4^{th} block 3050 corresponding to the third second decoding signal CSD3, the 5^{th} block 3052 corresponding to the second second decoding signal CSD2), the 6^{th} block 3054 corresponding to the first second decoding signal CSD1, and the 7^{th} block 3056 corresponding to the 0^{th} second decoding signal CSD0 are set as blocks of the data buffer area 3060, the start address 0800h of the data buffer area 3060 is not changed. However, the third block 3048 is set as the block of the data buffer area 3060, so the end address of the data buffer area 3060 is changed from 0BFFh (as shown in FIG. 3) to 0CFFh. That is, the 7^{th} block 3056 is a default first block of the data buffer area 3060, the 6^{th} block 3054 is a default second block of the data buffer area 3060, the 5^{th} block 3052 is a default third block of the data buffer area 3060, and the 4^{th} block 3050 is a default 4^{th} block of the data buffer area 3060. However, the third block 3048 is changed from a default 4^{th} block of the in-system programming area 3058 to a 5^{th} block of the data buffer area 3060, so the end address of the data buffer area 3060 is changed from 0BFFh (as shown in FIG. 3) to 0CFFh.

As shown in FIG. 6, FIG. 7, and FIG. 9, 8 select signals SS0-SS7 generated by the determination unit 3016 according to size of a program intended to be written in the in-system programming area 3058 are binary signals “1”, “1”, “1”, “1”, “1”, “0”, “0”, “0” in turn. Because the first select signal SS0 is a binary signal “1”, the select unit 30180 outputs a 0^{th} first decoding signal CSI0 to enable the 0^{th} block 3042 according to the first select signal SS0. That is, the 0^{th} block 3042 is set as a block of the in-system programming area 3058; because the select signal SS1 is a binary signal “1”, the select unit 30181 outputs a first first decoding signal CSI1 to enable the first block 3044 according to the select signal SS1. That is, the first block 3044 is set as a block of the in-system programming area 3058; because the select signal SS2 is a binary signal “1”, the select unit 30182 outputs a second first decoding signal CSI2 to enable the second block 3046 according to the select signal SS2. That is, the second block 3046 is set as a block of the in-system programming area 3058; because the select signal SS3 is a binary signal “1”, the select unit 30183 outputs a 4^{th} second decoding signal CSD4 to enable the third block 3048 according to the select signal SS3. That is, the third block 3048 is set as a block of the in-system programming area 3058; because the select signal SS4 is a binary signal “1”, the select unit 30184 outputs a 4^{th} first decoding signal CSI4 to enable the 4^{th} block 3050 according to the select signal SS4. That is, the 4^{th} block 3050 is set as a block of the in-system programming area 3058; because the select signal SS5 is a binary signal “0”, the select unit 30185 outputs the second second decoding signal CSD2 to enable the 5^{th} block 3052 according to the select signal SS5. That is, the 5^{th} block 3052 is set as a block of the data buffer area 3060; because the select signal SS6 is a binary signal “0”, the select unit 30186 outputs the first second decoding signal CSD1 to enable the 6^{th} block 3054 according to the select signal SS6. That is, the 6^{th} block 3054 is set as a block of the data buffer area 3060; because the select signal SS7 is a binary signal “0”, the select unit 30187 outputs a 0^{th} second decoding signal CSD0 to enable the 7^{th} block 3056 according to the select signal SS7. That is, the 7^{th} block 3056 is set as a block of the data buffer area 3060. As shown in FIG. 9, because the 0^{th} block 3042 corresponding to the 0^{th} first decoding signal CSI0, the first block 3044 corresponding to the first first decoding signal CSI1, the second block 3046 corresponding to the second first decoding signal CSI2, the third block 3048 corresponding to the third first decoding signal CSI3, and the 4^{th} block 3050 corresponding to the 4^{th} first decoding signal CSI4) are set as blocks of the in-system programming area 3058, the start address 0000h of the in-system programming area 3058 is not changed. However, the 4^{th} block 3050 is set as the block of the in-system programming area 3058, so the end address of the in-system programming area 3058 is changed from 03FFh (as shown in FIG. 3) to 04FFh. As shown in FIG. 9, because the 5^{th} block 3052 corresponding to the second second decoding signal CSD2, the 6^{th} block 3054 corresponding to the first second decoding signal CSD1, and the 7^{th} block 3056 corresponding to the 0^{th} second decoding signal CSD0 are set as blocks of the data buffer area 3060, the start address 0800h of the data buffer area 3060 is not changed. However, the 4^{th} block 3050 is set as the block of the in-system programming area 3058, so the end address of the data buffer area 3060 is changed from 0BFFh (as shown in FIG. 3) to 0AFFh. That is, the 7^{th} block 3056 is a default first block of the data buffer area 3060, the 6^{th} block 3054 is a default second block of the data buffer area 3060, the 5^{th} block 3052 is a default third block of the data buffer area 3060. However, the 4^{th} block 3050 is changed from a default 4^{th} block of the data buffer area 3060 to a 5^{th} block of the in-system programming area 3058, so the end address of the data buffer area 3060 is changed from 0BFFh (as shown in FIG. 3) to 0AFFh.

Because the start address 0000h of the in-system programming area 3058 and the start address 0800h of the data buffer area 3060 are not changed, the designer of the memory array 300 can rewrite developed programs easily. But, the present invention is not limited to relationships of the 8 select units 30180-30187, the 8 select signals SS0-SS7, the 8 first decoding signals CSI0-CSI7, the 8 second decoding signals CSD0-CSD7, and the 8 blocks 3042-3056 in FIG. 6. That is to say, the start address 0000h of the in-system programming area 3058 and the start address 0800h of the data buffer area 3060 can be also changed with a requirement of the designer of the memory array 300.

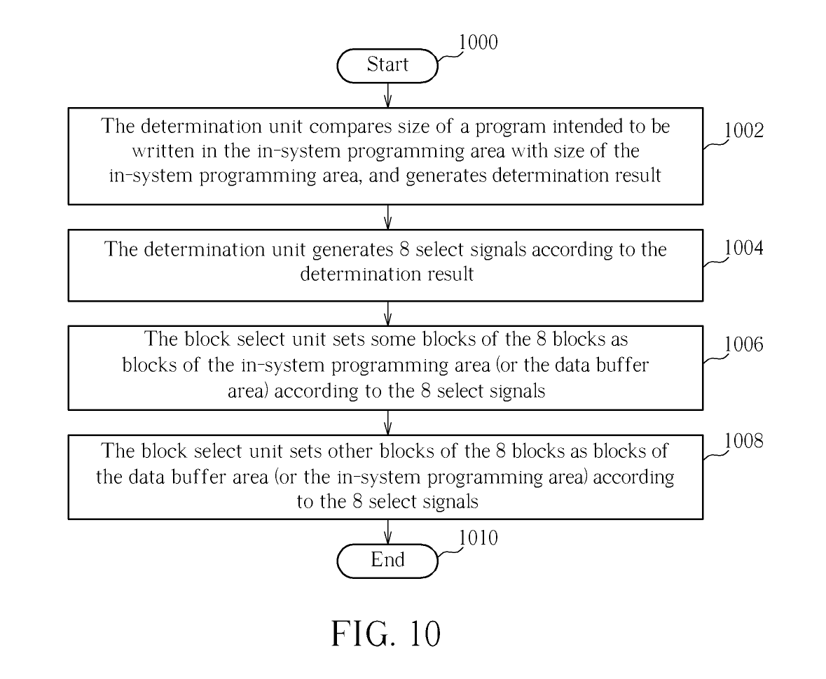

Please refer to FIG. 10 and FIG. 3. FIG. 10 is a flowchart illustrating a method for setting a plurality of blocks as an in-system programming area and a data buffer area according to another embodiment. The method in FIG. 10 is illustrated using the circuit 301 in FIG. 3. Detailed steps are as follows:

Step 1000: Start.

Step 1002: The determination unit 3016 compares size of a program intended to be written in the in-system programming area 3058 with size of the in-system programming area 3058, and generates determination result.

Step 1004: The determination unit 3016 generates 8 select signals SS0-SS7 according to the determination result.

Step 1006: The block select unit 3018 sets some blocks of the 8 blocks 3042-3056 as blocks of the in-system programming area 3058 (or the data buffer area 3060) according to the 8 select signals SS0-SS7.

Step 1008: The block select unit 3018 sets other blocks of the 8 blocks 3042-3056 as blocks of the data buffer area 3060 (or the in-system programming area 3058) according to the 8 select signals SS0-SS7.

Step 1010: End.

In Step 1002, the determination unit 3016 compares the size of the program intended to be written in the in-system programming area 3058 with the size of the in-system programming area 3058, and generates the determination result. That is to say, the determination unit 3016 compares the size of the program intended to be written in the in-system programming area 3058 with size of the block 3042-3048 to generate the determination result. In Step 1004, in another embodiment of the present invention, the 8 select signals SS0-SS7 can be set by a user. That is to say, the user can set the 8 select signals SS0-SS7 according to a practical requirement. If the 8 select signals SS0-SS7 are set by the user, Step 1002 can be omitted. In Step 1006 and Step 1008, as shown in FIG. 6, each select unit of the 8 select units 30180-30187 corresponds to one block of the 8 blocks 3042-3056, one first decoding signal of 8 first decoding signals CSI0-CSI7, one select signal of 8 select signals SS0-SS7, and one second decoding signal of 8 second decoding signals CSD0-CSD7, and determines to output the first decoding signal or the second decoding signal to enable the block according to the select signal. Therefore, the circuit 301 can set some blocks of the 8 blocks 3042-3056 as blocks of the in-system programming area 3058 and other blocks of the 8 blocks 3042-3056 as blocks of the data buffer area 3060 according to according to the size of the program intended to be written in the in-system programming area 3058. In another embodiment of the present invention, the circuit 301 can set some blocks of the 8 blocks 3042-3056 as blocks of the in-system programming area 3058 and other blocks of the 8 blocks 3042-3056 as blocks of the data buffer area 3060 according to the requirement of the user (that is, the user sets the 8 select signals SS0-SS7 according to the requirement).

To sum up, the circuit for setting a plurality of blocks as the in-system programming area and the data buffer area and method thereof utilize the determination unit to compare size of a program intended to be written in the in-system programming area with size of the in-system programming area, and generate a plurality of select signals according to a determination result, or a plurality of select signals set by the user. Then, the block select unit can set some blocks of the plurality of blocks as blocks of the in-system programming area and set other blocks of the plurality of blocks as blocks of the data buffer area according to the plurality of select signals. Thus, the present invention can not only increase flexibility of programming-program of the designer of the memory array, but also reduce a revision probability for the memory array due to a structure problem of the memory array.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A circuit for setting a plurality of blocks as an in-system programming area and a data buffer area, the circuit comprising:
an in-system programming address decoding unit for generating a plurality of first decoding signals corresponding to the plurality of blocks according to a plurality of block address signals and a select signal;
a data buffer address decoding unit for generating a plurality of second decoding signals corresponding to the plurality of blocks according to the plurality of block address signals and the select signal; and
a block select unit comprising a plurality of select units, wherein each select unit corresponds to one block of the plurality of blocks, one first decoding signal of the plurality of first decoding signals, one select signal of a plurality of select signals, and one second decoding signal of the plurality of second decoding signals, and determines to output the first decoding signal or the second decoding signal to enable the block according to the select signal.

2. The circuit of claim 1, further comprising:
a determination unit for comparing size of a program intended to be written in the in-system programming area with size of the in-system programming area, and generating the plurality of select signals according to a determination result.

3. The circuit of claim 1, wherein the plurality of select signals are set by a user.

4. The circuit of claim 1, wherein each block of the plurality of blocks is a random access memory block.

5. The circuit of claim 1, wherein the a plurality of block address signals comprises a first block address signal, a second block address signal, and a third block address signal, and the plurality of blocks comprises 8 blocks.

6. A method for setting a plurality of blocks as an in-system programming area and a data buffer area, the method comprising:
generating a plurality of select signals; and
setting some blocks of the plurality of blocks as blocks of the in-system programming area or the data buffer area according to the plurality of select signals.

7. The method of claim 6, wherein generating the plurality of select signals comprises:
comparing size of a program intended to be written in the in-system programming area with size of the in-system programming area, and generating a determination result; and
generating the plurality of select signals according to the determination result.

8. The method of claim 6, wherein the plurality of select signals are set by a user.

9. The method of claim 6, further comprising:
setting other blocks of the plurality of blocks as blocks of the data buffer area according to the plurality of select signals when the some blocks of the plurality of blocks are set as the blocks of the in-system programming area.

10. The method of claim 6, further comprising:
setting other blocks of the plurality of blocks as blocks of the in-system programming area according to the plurality of select signals when the some blocks of the plurality of blocks are set as the blocks of the data buffer area.
